(19) United States
(12) Patent Application Publication
(10) Pub. No.: US 2004/0078755 A1
(43) Pub. Date: Apr. 22, 2004

(54) System and method for processing forms

(75) Inventors: Hiroshi Shinjo, Kodaira (JP); Naohiro Furukawa, Hachioji (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/445,926

(22) Filed: May 28, 2003

(30) Foreign Application Priority Data
Oct. 21, 2002 (JP) 2002-305283

(51) Int. Cl. G06F 17/00

(52) U.S. Cl. 715/505

(57) ABSTRACT

A system and method are provided for a format processor that precisely matches a format of a semi-fixed form in the same form type is disclosed. In one example, the form processing system comprises a storage device configured to store format information of a plurality of fields of a form; an image input device configured to acquire an image of a plurality of segments of the form; a reading device configured to read the format information of the plurality of fields of the form from the storage device; a matching device configured to match format information of the plurality of segments with corresponding format information of the plurality of fields to obtain matching results; and a combining device configure to combine the format information of the plurality of segments with corresponding format information of the plurality of fields based upon the matching results, wherein the combining device is further configured to obtain a determined format of the image.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention generally relates to optical character readers (OCRs) and to form processing systems and, more particularly, to a format information generator that defines the position of a character entered on a form, a program for operating the generator, a form processing system that recognizes the form using format information, and a program for operating the processor.

2. Discussion of Background

Form “format information” means information that defines a cell and a field where a character and a check mark are described for reading the character on a form and detecting the position. Format information may include not only coordinate information but an attribute such as a read item name of the field and the type of the character.

For additional detail of an example of one format information being stored for one form type, see the description of a “format generator” described in “Hitachi Imaging OCR Products” Catalog '99 Jun. Edition, page 11. Format information utilized in the format generator strictly specifies the position of a character cell and a text field box every form type. Many types of the existing OCRs adopt the similar format information to that of the format generator.

For a additional detail of a method of automatically detecting the position of a cell by defining the structure of a list on a form beforehand and matching an input image on the form with the list, see Japanese Patent Application No. 282193/1995. This method produces an effect such that the difference of the position of a cell caused by partial distortion and by an error in cutting a form can be detected for a fixed form. Also, the matching with the list strong in a faint line or the interruption of a line and noise is enabled.

For additional detail of a method of adopting relation in the arrangement between cells on a form as format information, see refer to “A Framework of Layout Recognition for Document Understanding,” by Watanabe et al., Proceeding of Symposium on Document Analysis and Information Retrieval, 1992, pages. 77 to 95. In this method, relation in the arrangement between cells on the overall form is described as a model beforehand. The method produces an effect such that the position of a cell can be detected by matching an input image on a form with the model even if a form includes cells different in not only the position but the size.

The type of a form processed by a form processing system will be described. A form except a form dedicated to OCR is classified into three types of a fixed form, a semi-fixed form, and a non-fixed form from the viewpoint of a format. The fixed form means a form of the same type in which the position of a rule and a character is fixed. The semi-fixed form means a form in which the position of a rule and a cell is subtly different every form even if forms are of the same type as in a certificate of income and withholding tax and a receipt of a fee for medical examination. If difference between the positions of a rule and a cell is within 20% of the size of a form, the form is called a semi-fixed form. The non-fixed form means a form the format and the contents of which are different even if forms are of the same type as in a receipt and means a form except the semi-fixed form.

The problem of a semi-fixed form will be described below using a certificate of income and withholding tax shown in FIG. 3 as an example. Though the arrangement of a cell is substantially determined in a certificate of income and withholding tax, the position of a cell is subtly different every form. This reason is that a company that issues the certificate determines a strict format such as the size of a cell on its own terms though a rough format such as the order of the arrangement of items is determined.

FIGS. 18A, 18B, and 18C show examples of forms having differences in formatting. FIG. 18A shows examples of forms having the same items and different in the size of a cell. FIG. 18B shows examples of forms different in whether a line segment exists or not and the length of a line segment mainly in a field of the sum of money. FIG. 18C shows examples of forms in which the arrangement of a cell itself is different. For a problem common to the recognition of a form, there is a problem of the quality of an image in addition to the difference described above in a format. As the quality and a state of the printing of a form are various, the quality of an image when the image is input is not fixed and a faint line and noise may be caused. When a faint line and noise are caused, probability that wrong correspondence is made is increased in case the position of a rule and a cell is judged based upon an image on a form.

It is difficult to recognize the semi-fixed form having characteristics described above by the prior art described above.

As the first conventional example premises that the position of a cell and a character is the same, it is difficult to recognize a semi-fixed form. It is capable to recognize a semi-fixed form in principle by all registering the format information of a form to be recognized. However, the recognition is realistically very difficult for the following three reasons. A first reason is that the cost for generating format information is increased because the number of the format information to be generated of a form is enormous. A second reason is that it is difficult to prepare all forms beforehand and to generate their format information. In the example of the certificate of income and withholding tax, it is required to collect certificates of income and withholding tax issued by all domestic companies. In addition, as the same company may change a format every year, it is impossible to collect all. A third reason is that even if the two problems described above can be solved, it is very difficult to realize technique for discriminating subtle difference in a format and automatically selecting suitable format information.

In the second conventional example, though difference in the position of a character cell and a text field box can be solved, it is impossible to recognize a semi-fixed form different in the size of a cell.

In the third conventional example, though difference in the position and the size of a character cell and a text field box can be solved, the format information of the whole form is required to be newly generated even if only the arrangement of a cell in a segmented field of the form is different. Therefore, to recognize a semi-fixed form in which the arrangement of a cell is subtly different every form, there is a problem that the number of format information is enormous. As a model used in this method cannot include a cell except a rectangular cell, there is a problem that many forms having existing corresponding model. Further, as in this method, matching is made based upon the arrangement information of cells, there is a problem that this method is not suitable for an image on a form in which a cell cannot be precisely extracted because of a faint line and noise.

### SUMMARY OF THE INVENTION

An object of the invention is to solve problems associated with recognizing a semi-fixed form. The invention provides a format processor that precisely matches a format of a semi-fixed form in the same form type. The position and the size of a cell is different and the arrangement of a part of cells is different based upon small format information. Further, the invention provides a form processing system that can also match a format of a low quality of image on a form. It should be appreciated that the present invention can be implemented in numerous ways, including as a process, an apparatus, a system, a device or a method. Several inventive embodiments of the present invention are described below.

In one embodiment, a form processing system is provided that comprises a storage device configured to store format information of a plurality of fields of a form; an image input device configured to acquire an image of a plurality of segments of the form; a reading device configured to read the format information of the plurality of fields of the form from the storage device; a matching device configured to match format information of the plurality of segments with corresponding format information of the plurality of fields to obtain matching results; and a combining device configure to combine the format information of the plurality of segments with corresponding format information of the plurality of fields based upon the matching results, wherein the combining device is further configured to obtain a determined format of the image.

In another embodiment, a method for form processing on a system having a storage device is provided. The method comprises storing formation information of a plurality of fields of a form; acquiring an image of a plurality of segments of the form; reading the format information of the plurality of fields of the form from the storage device; matching the format information of the plurality of segments with corresponding format information of the plurality of fields to obtain matching results; and combining the format information of the plurality of segments with corresponding format information of the plurality of fields based upon the matching results; and obtaining a determined format of the image.

In still another embodiment, a method if provided for form processing. The method comprises acquiring an image of a form; displaying the image; analyzing the layout of the image; extracting a grid representation of the layout of the image; storing the grid representation into a storage device; specifying a segment of the image; reading the grid representation as applied to the segment from the storage device; and relating attribute information of the segment to the grid representation to obtain relation results; and storing the relation results in the storage device, wherein the step of reading and the step of relating are applied to a segment newly specified in a field other than the segment.

The invention encompasses other embodiments of a method, an apparatus, and a computer-readable medium, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram showing the schematic configuration of a form processing system in an embodiment of the present invention;

FIG. 2 is a flowchart showing form processing in an embodiment of the present invention;

FIG. 3 shows an example of an object of form processing;

FIG. 4 shows the division in a field of a form shown in FIG. 3, in accordance with an embodiment of the present invention;

FIG. 5 shows the configuration of segmented format information in an embodiment of the present invention;

FIG. 6 is a flowchart showing matching with segmented format information in the format processing shown in FIG. 2, in accordance with an embodiment of the present invention;

FIG. 7A shows an input image, in accordance with an embodiment of the present invention;

FIG. 7B explains the grid representation of the input image used for a feature in matching with a segmented format, in accordance with an embodiment of the present invention;

FIG. 8 shows the shape of a crossing point of the grid representation, in accordance with an embodiment of the present invention;

FIG. 9A shows an example of an image in a segment corresponding to segmented format information, in accordance with an embodiment of the present invention;

FIG. 9B explains segmented format information, in accordance with an embodiment of the present invention;

FIG. 10 shows an example of the internal data of segmented format information, in accordance with an embodiment of the present invention;

FIG. 11 is a flowchart showing matching with a segmented format in matching with the segmented format shown in FIG. 6, in accordance with an embodiment of the present invention;

FIG. 12A shows an image in a limited field to be matched, in accordance with an embodiment of the present invention;

FIG. 12B explains the generation of a grid point to be matched in a segment based upon the input image in this embodiment, in accordance with an embodiment of the present invention;

FIG. 13 shows the matching of grid points using dynamic programming (DP), in accordance with an embodiment of the present invention;

FIG. 14 explains transition between nodes and the calculation of a score in the matching using DP shown in FIG. 13, in accordance with an embodiment of the present invention;

FIG. 15 explains the calculation of a score in the matching using DP shown in FIG. 13, in accordance with an embodiment of the present invention;

FIG. 16 explains a step shown in FIG. 11 of verifying a result of performing a matching operation, in accordance with an embodiment of the present invention;

FIG. 17 is a flowchart showing the generation of segmented format information, in accordance with an embodiment of the present invention; and

FIG. 18A shows examples of forms having the same items and different in the position and the size of a cell;

FIG. 18B shows examples of forms showing the diversity of a line or a ling segment in a field of the sum of money; and

FIG. 18C shows examples of forms different in the arrangement of cells.

### DESCRIPTION OF THE PREFERRED EMBODIMENTS

An invention for a format processor that precisely matches a format of a semi-fixed form in the same form type is disclosed. Numerous specific details are set forth in order to provide a thorough understanding of the present invention. It will be understood, however, to one skilled in the art, that the present invention may be practiced without some or without all of these specific details. Generally, the term “device” as used in the present invention means hardware, software, or combination thereof.

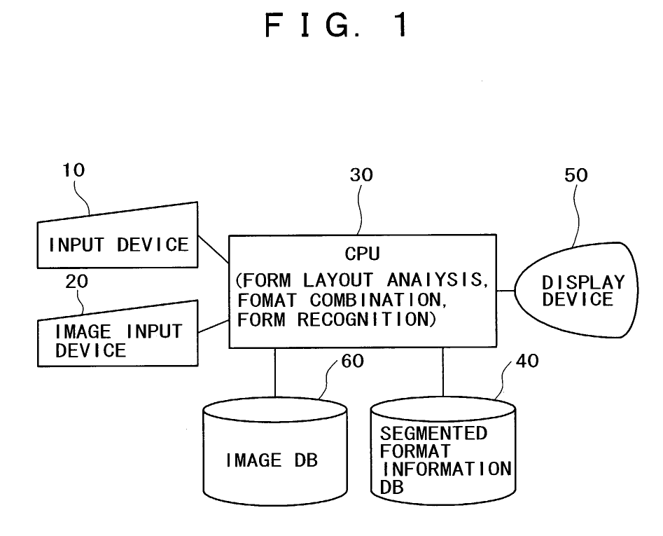

FIG. 1 shows an example of the hardware configuration of a form processing system which is one embodiment of the invention. As shown in FIG. 1, a reference number 10 denotes an input device for inputting a command and code data, 20 denotes an image input device for inputting an image on a form to be processed, 30 denotes a form recognition system that analyzes and collates a format, 40 denotes a database that stores segmented format information, and 50 denotes a display device that displays the result of recognition. In place of the image input device shown as 20, an image on a form may be also input from an image database shown as a reference number 60.

Before the concrete contents of processing are described, the policy and effect of the invention will be described.

In the invention, to solve the problems described above, a form is segmented and format information is generated every segment. In the invention, this is called segmented format information. Segmented format information is generated by the number of different formats in the same field.

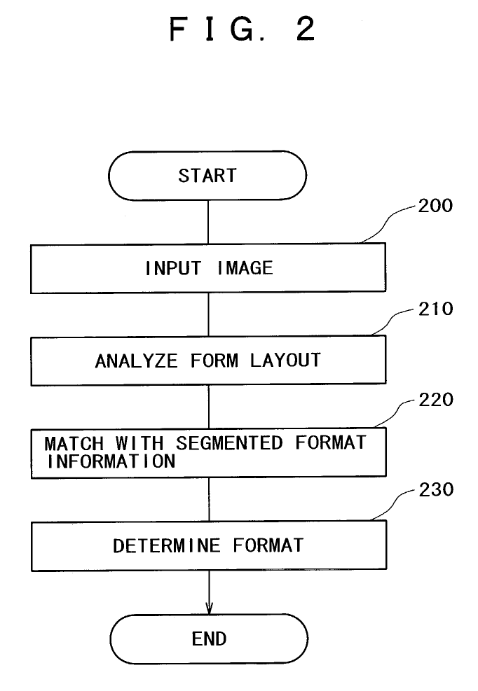

In form processing, the format information of the whole form can be acquired by matching an image on the form and segmented format information every segment, dynamically selecting optimum segmented format information and synthesizing the result. Referring to FIG. 2, the details of the form processing using segmented format information will be described later.

The problems of a semi-fixed form can be solved by the form processing as follows.

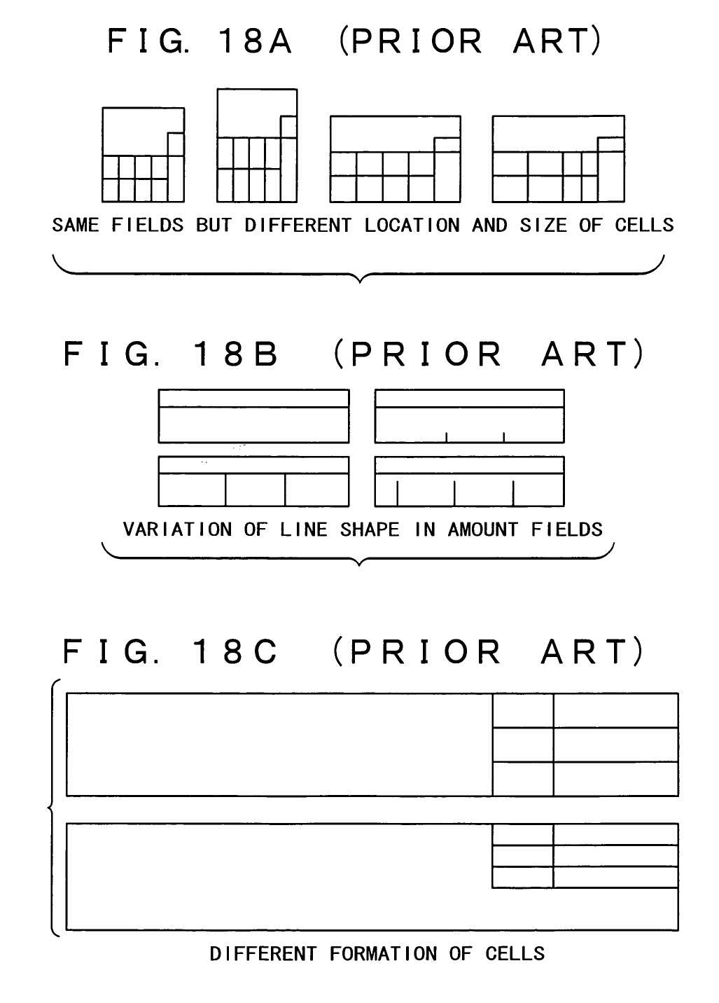

First, the problem shown in FIG. 18A of the semi-fixed form can be solved by adopting a method of absorbing difference in the position and the size between cells in matching. Next, the problem shown in FIG. 18B can be solved by adopting a method of differentiating an unnecessary line segment and the rule of a cell in matching. Further, high-precision processing can be also applied to a low-quality image by adopting these matching methods and differentiating a faint rule and a line segment caused by noise from a proper rule.

The problem shown in FIG. 18C can be solved by defining a plurality of segmented format information in the same field. Even if the arrangement of cells is different, suitable segmented format information can be acquired by matching a plurality of segmented format information for the same segment and selecting segmented format information which is the most similar.

When format information every segment is determined, the position of a character cell and a text field box can be detected based upon an image on a form utilizing information recorded in the format information. As described above, a form processing system that recognizes the semi-fixed form can be realized by adopting format matching utilizing segmented format information.

In a conventional method, the format information of the following whole form is required to be generated every form of a new format, however, in the invention, as the format information of only a segment which does not correspond to the existing segmented format information has only to be added, the cost of generating format information can be greatly reduced.

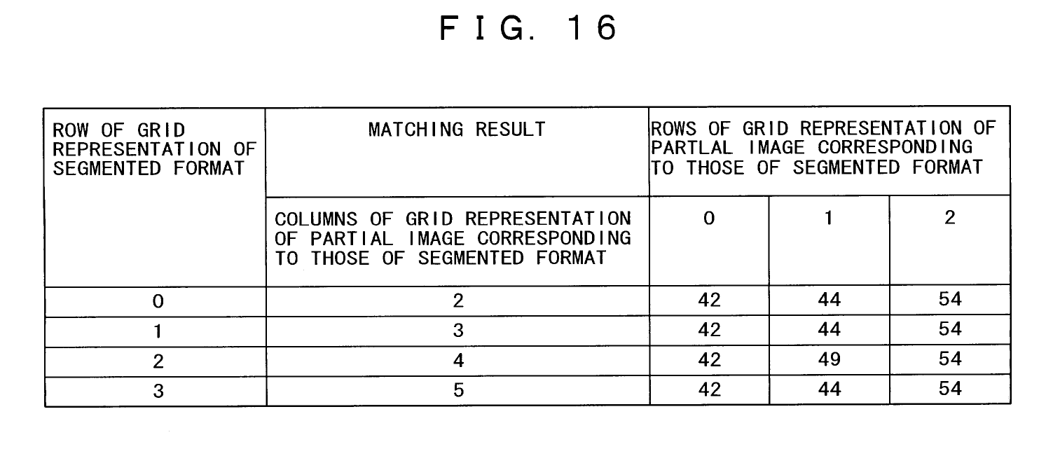

A procedure for generating segmented format information is as follows. First, a feature for describing a format is generated by inputting an image on a form and analyzing its format such as extracting a rule. Next, a segment the segmented format information of which is to be generated is selected by a user. An error of the feature caused by being faint and noise in the selected segment is corrected by the user. Finally, when an individual cell is specified based upon the feature of the segment and the user specifies the attribute of each cell, segmented format information can be generated. Referring to FIG. 16, the details of a process for generating segmented format information will be described later.

Referring to the following drawings, the details of processing will be described below.

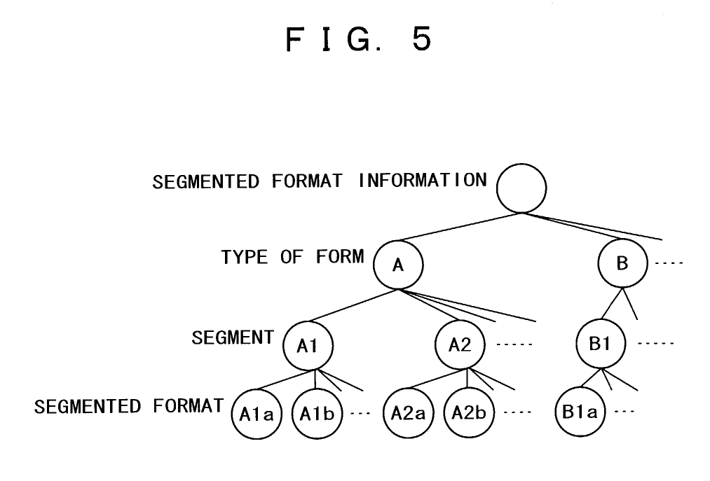

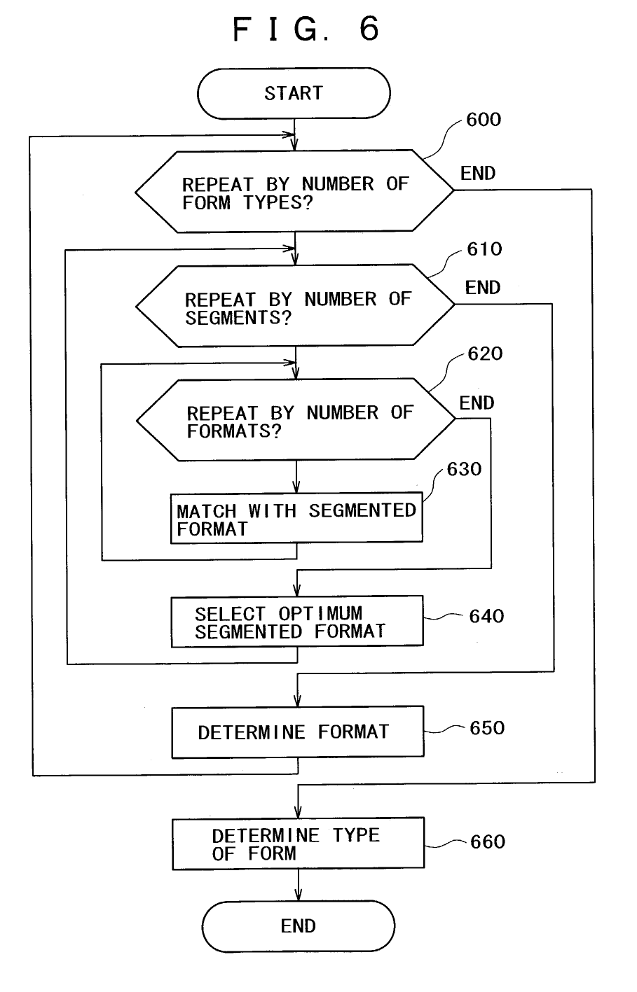

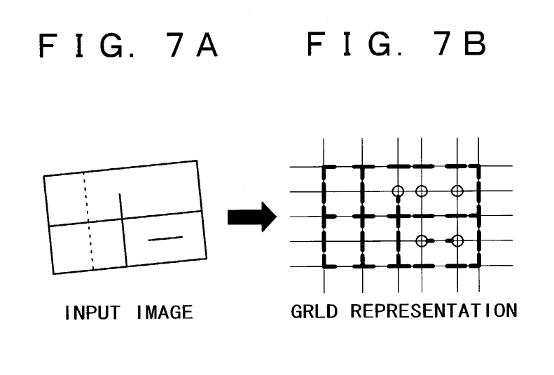

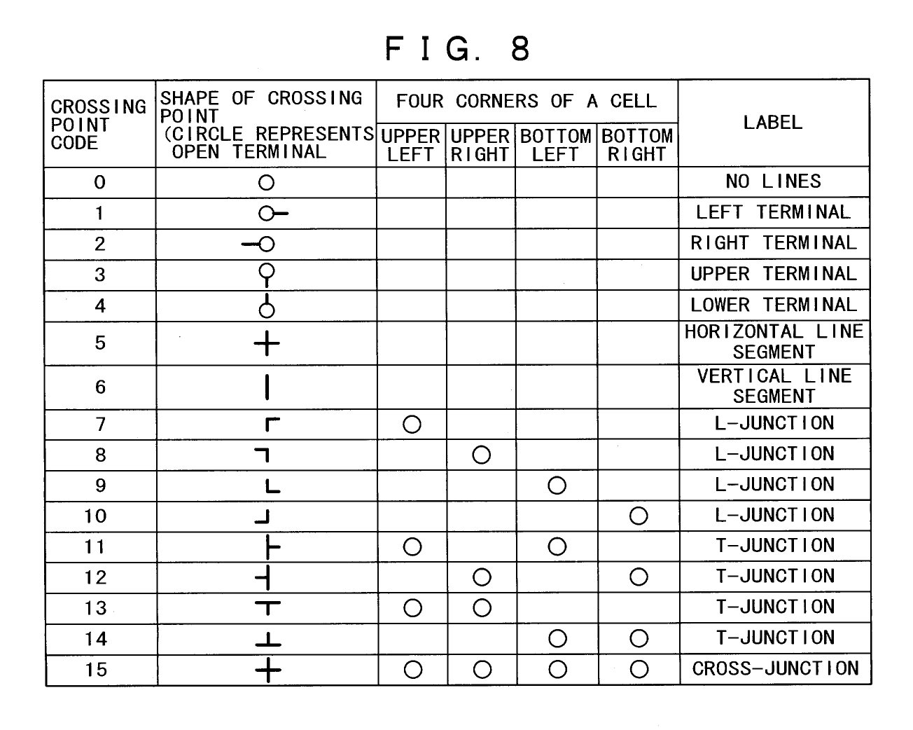

FIG. 2 is a flowchart showing the outline of form processing by the form processing system according to the invention. In a step 200, an image on a form is input from the image input device 20 or the image database 60. In a step 210, the layout of the image on the form is analyzed and a feature to be utilized in a step 220 is extracted. Referring to FIGS. 7 and 8, the feature will be described later. In the step 220, each segment of the image on the form is matched with segmented format information stored in the segmented format information database 40 and segmented format information which is the most similar is selected. Referring to FIG. 5, segmented format information will be described later and referring to FIG. 6, matching processing will be described later. In a step 230, the format information of the whole form is determined based upon segmented format information determined every segment.

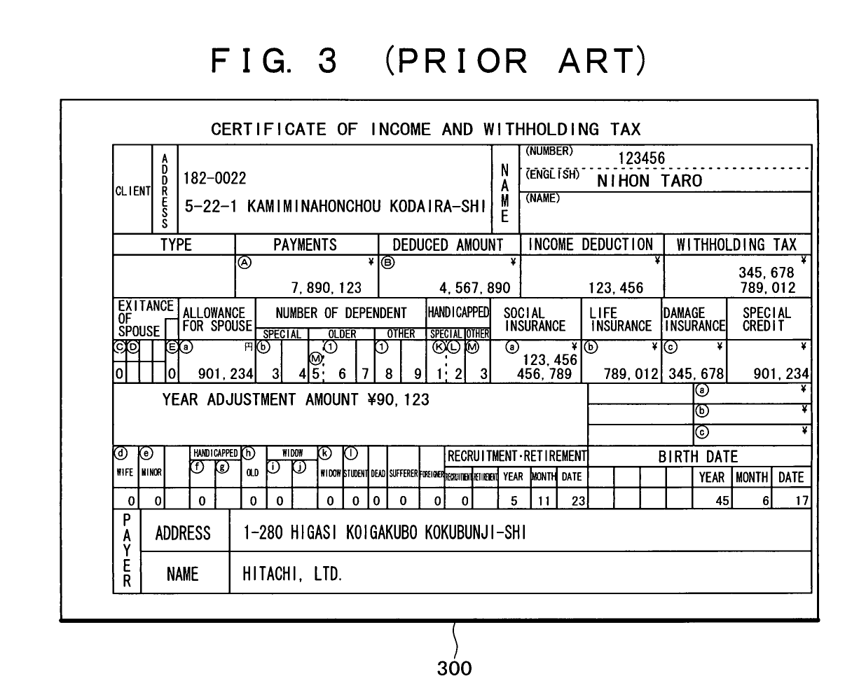

Referring to FIGS. 3 to 5, a concrete example of a segment and segmented format information respectively used in the invention will be described before the details of form processing is described.

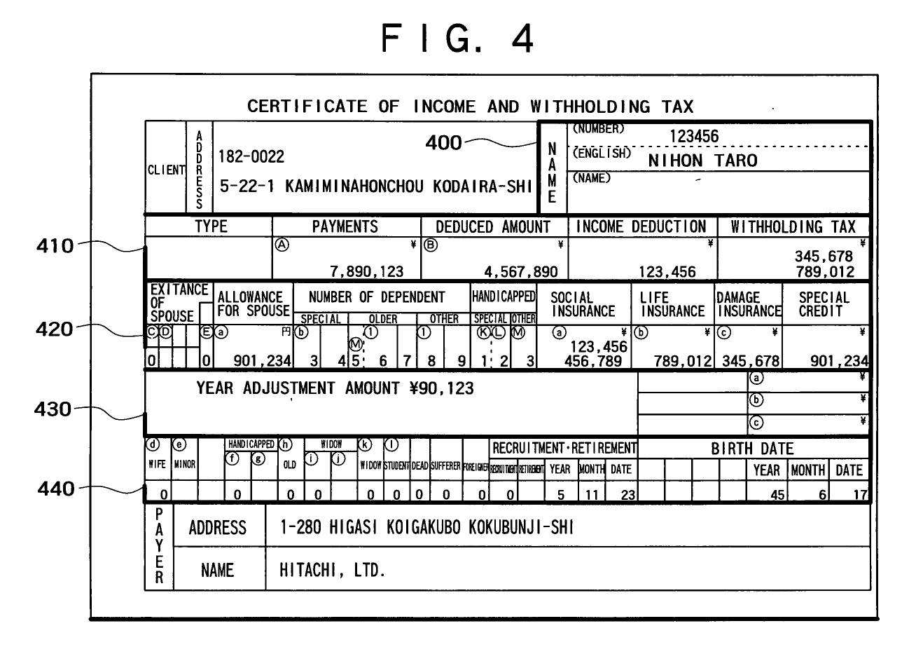

FIG. 3 shows a certificate of income and withholding tax which is an example of a semi-fixed form to be processed. Fields 400 to 440 shown by a thick line in FIG. 4 denote segments set in the certificate of income and withholding tax shown in FIG. 3. An example of criteria based upon which a segment arbitrarily set every form type is set will be described below. For a first criterion, as in the field 400, one segment includes a cell in which an item name is described and a cell in which data is described. These two cells are called an item name cell and a data cell. A set of plural item name cells and plural data cells may be also included in one field. For a second criterion, as in the fields 410 to 440, each field is divided by a long rule dividing the whole field horizontally or vertically. In the fields 410 to 440, the rule dividing each field exists, however, each field is set based upon the first criterion that the item name cell and the data cell exist in the same field. Segmented format information is generated every segment.

FIG. 5 shows the structure of segmented format information stored in the segmented format information database 40. The segmented format information has tree structure composed of three hierarchies of a form type, a segment and a segmented format. In an example shown in FIG. 5, for the form type, A, B, and others are stored. The form type A is divided into segments A1, A2, and others. The segment A1 includes segmented formats A1a, A1b, and others which are different in the arrangement of cells. The number of elements in each hierarchy may be also one if necessary.

Effect utilizing segmented format information is as follows. If segmented formats are dynamically synthesized and the format of the whole form is generated when the form is recognized, the format information of multiple forms different in a layout can be synthesized based upon small segmented formats. In the example of the certificate of income and withholding tax, assuming that respective three segmented formats exist in five segments, the format information of 243 (the fifth power of 3) types of whole forms can be synthesized based upon 15 (3×5) pieces of segmented formats.

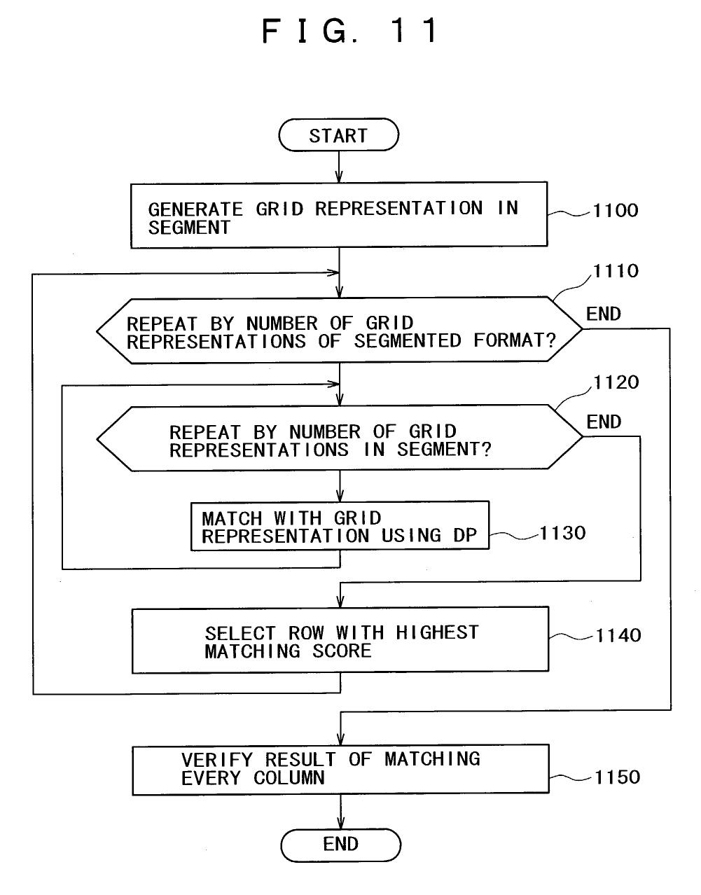

Next, referring to FIG. 6, the details of the segmented format matching process in the step 220 shown in FIG. 2 will be described. In a step 600, processing in steps 610 to 650 is repeated by the number of form types to be processed. For example, in case two types of a certificate of income and withholding tax and a final income tax return are input, the processing is repeated twice. In the step 610, processing in the steps 620 to 640 is repeated by the number of segments. As the certificate of income and withholding tax shown in FIG. 4 is divided into five segments, the processing is repeated five times. In the step 620, processing in the step 630 is repeated by the number of segmented formats defined every segment. In the step 630, the input image and a segmented format are matched and the degree of similarity is calculated. Referring to FIGS. 11 to 16, the details of the matching process will be described later. In the step 640, the optimum segmented format of each field is selected. For one example of a selecting method, a method of selecting a segmented format which is the most similar of segmented formats acquired in the step 630 can be given. In the step 650, the optimum format information of the whole form is determined every form type. For one example of this processing, a method of synthesizing the optimum segmented formats acquired in the step 640 can be given. In a step 660, the form type of the input image is determined. For one example of the processing, a method of calculating the degree of similarity every form type of the format of the whole form acquired in the step 650 and selecting a form type which is the most similar can be given. The form type and format information can be determined by a series of process described above.

In case a form type is one and a form type is determined beforehand by another processing and the specification of a user, the processing in the step 600 and the step 660 can be omitted. Similarly, in case the whole form is composed of one field and a segment is one, the processing in the steps 610 and 650 can be omitted.

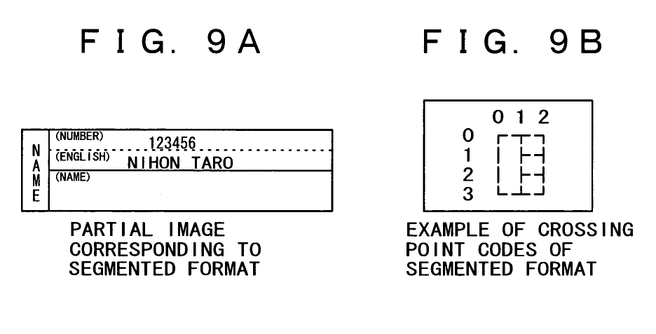

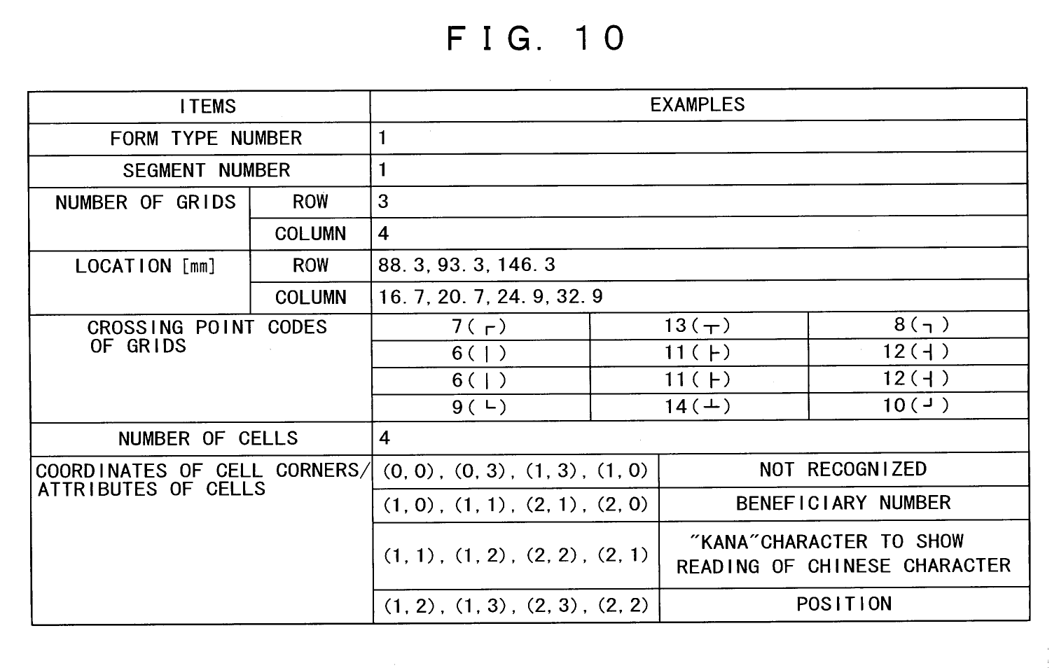

A method of matching with segmented format information will be described in detail below. First, referring to FIGS. 7 and 8, a feature utilized in matching will be described, referring to FIGS. 9 and 10, the contents of data stored in matched segmented format information will be described, and referring to FIGS. 11 to 16, the algorithm of a concrete matching process will be described. One embodiment of a matching method will be described below, however, matching with a segmented format may be also realized using another means.

FIG. 7 shows an example of a feature used for matching with a segmented format. In the invention, the feature is called grid representation. A method of generating grid representation is disclosed in JP-A No. 053466/1999. The grid representation means the arrangement information of points called a grid point. The grid point is defined as a crossing point of auxiliary lines virtually extended horizontally and vertically from the endpoints of all full lines and dotted lines the inclination of which is corrected. At each grid point, coordinate values before and after the inclination is corrected and the shape of crossed rules are recorded.

FIG. 8 shows an example of codes (cross point codes) added according to a type of a crossing point at each grid point. A crossing point code 0 denotes that no rule exists. Crossing point codes 1 to 4 denote the endpoint of a rule. Crossing point codes 5 and 6 denote a part of a rule. Crossing point codes 7 to 10 denote a crossing point at which two rules are crossed in L-type. Crossing point codes 11 to 14 denote a crossing point at which two rules are crossed in T-type. A crossing point code 15 denotes a crossing point at which two rules are crossed in a cross.

As shown in FIG. 7, the cell structure of a form can be described using grid representation. The coordinates of a crossing point of orthogonal rules can be acquired based upon the coordinate values of the corresponding grid point. Distance between parallel two vertical rules can be calculated based upon distance between grid points at which the rule exists. A rectangular cell on a form can be represented by the combination of grid points equivalent to the four corners of the cell.

An example of a method of extracting full lines for generating grid representation is disclosed in JP-A No. 232382/1999 and an example of extracting dotted lines is disclosed in JP-A No. 319824/1997.

FIGS. 9 show examples of an image of a segment of a form corresponding to segmented format information and its grid representation. FIG. 10 shows an example of the data of segmented format information generated based upon the grid representation.

For the example of the data of the segmented format information shown in FIG. 10, first, a format type number is stored. Next, a segment number is stored. Next, the number of grid points in rows and in columns is stored. In the example shown in FIG. 9, as grid representation is arranged on four rows and in three columns, the number of grid points in a horizontal direction is 3 and the number in a vertical direction is 4. Next, the coordinate values of a grid point in the horizontal direction and in the vertical direction with an arbitrary position on a form as a home position are recorded. Distance between parallel rules, that is, the width and the height of a cell can be acquired by utilizing the values. Next, a crossing point code at each grid point is stored. The crossing point codes are shown in FIG. 8. For example, in grid representation shown in FIGS. 9, a crossing pint code at a grid point on a zeroth row and in a second column is 8. Next, the number of cells in the segment is stored. In the example shown in FIG. 9, as four cells exist, the number of cells is 4. Finally, the positions of grid points at the four corners of each cell and a read item are stored. When a grid point on an “i”th row and in a “j”th column is described as (i,j), the coordinates of the four corners of the frame of a field of a “kana” character to show the reading of a Chinese character shown in FIGS. 9 are (1,1), (1,2), (2, 2), and (2, 1) counterclockwise from the upper left. In addition, information such as the color information of a rule and a field and the discrimination of a full rule and a dotted rule at a grid point may be also added.

In case the type of a form to be processed is one in FIG. 10, a form type number may be also omitted. For the number of cells, not the number of all cells in a field but only the number of cells to be read may be also entered. In this case, “the coordinates of corners of a cell/the attribute of the cell” of only the read number are specified. Further, the shape of the cell may be also not only rectangular but polygonal such as L-type. In this case, grid points at the corners of the cell have only to be stored in order. Further, in this example, only the inside of a field is specified as a read field, however, the outside of the field may be also specified. In case the outside of the field is specified, grid points on a boundary of the field are specified as the positions of the corners.

Next, the algorithm of segmented format matching processing will be described.

In this embodiment, a matching method using dynamic programming (DP) utilized for speech recognition as an example of matching processing will be described. The principle of the dynamic programming is explained in various documents in addition to pp. 5 to 29 of the second vol. of “Algorithm Introduction” published by Kindai Kagakusha in 1995.

The reason why matching using DP is adopted as matching algorithm is the following two. First, as matching not depending upon the length of distance between features of objects of matching is enabled, correspondence to distance between rules shown in FIG. 18A, that is, difference in the size of a cell is enabled. Second, as matching hardly influenced by the increase or the decrease of the number of features is enabled, correspondence to the increase or the decrease of the number of rules caused by a low quality of image shown in FIG. 18B is enabled.

Normally, matching using DP is applied to one-dimensional data. As segmented format information is two-dimensional information, processing is divided into processing in a horizontal direction and processing in a vertical direction in this embodiment. In the concrete, a method of matching grid representation using DP in the horizontal direction and verifying the acquired result in the vertical direction is adopted. As a method of two-dimensional matching using DP is also proposed, the method can be also applied.

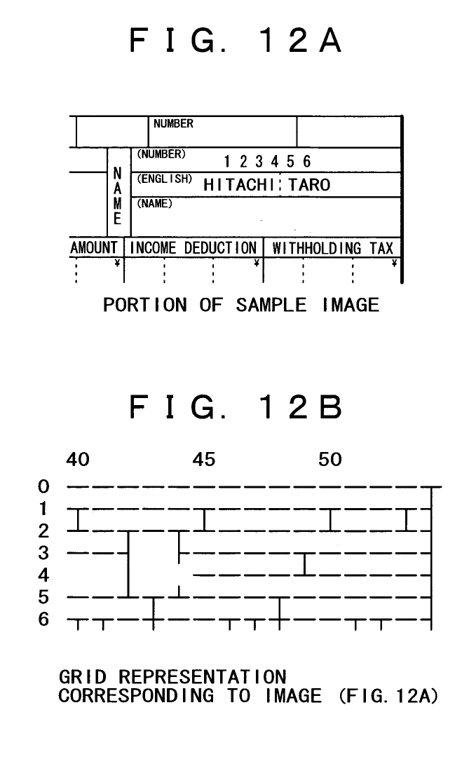

FIG. 11 is a flowchart showing a segmented format matching process using DP. In a step 1100, fields of objects to be matched are set every segment and only grid representation in the field is extracted from the grid representation of the whole form generated in the step 210. Referring to FIGS. 9 and 12, this processing will be concretely described below. First, a field of an input image corresponding to segmented format information shown in FIG. 9 is set as shown in FIG. 12A. This field is expanded in consideration of dislocation based upon the field of segmented format information shown in FIG. 9A. FIG. 12B shows the result of extracting grid representation of fields equivalent to fields shown in FIG. 12A from the grid representation of the whole form. In this example, the grid representation of a field on 0th to sixth rows and in 40eth to 54th columns is extracted. Hereinafter, the grid representation of a segment in an input image is called segment grid representation and grid representation in segmented format information is called format grid representation.

In a step 1110, processing in steps 1120 to 1140 is repeated every row of format grid representation. In an example shown in FIG. 9B, the processing is repeated from a zeroth row to a third row.

In the step 1120, processing in the step 1130 is repeated every row of segment grid representation. In an example shown in FIG. 12B, the processing is repeated from a zeroth row to a sixth row.

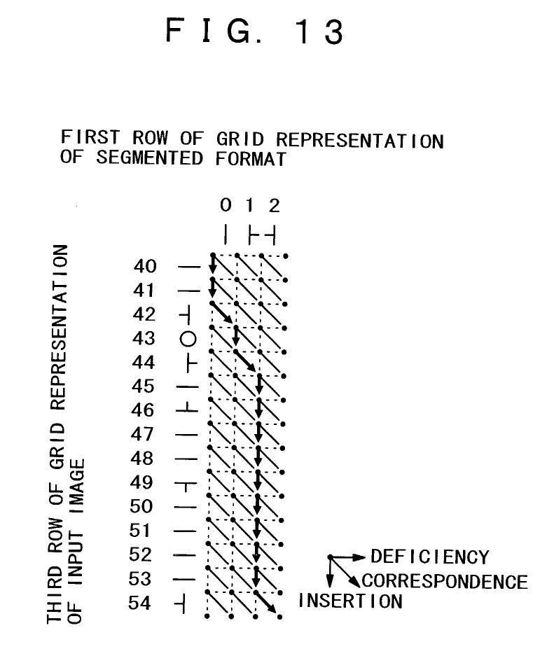

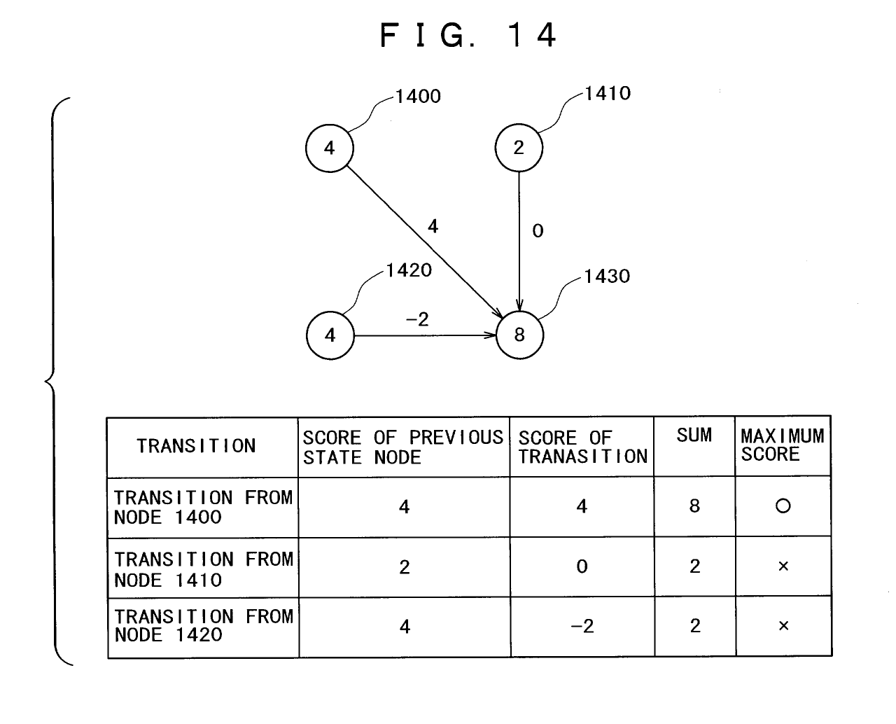

In the step 1130, rows of format grid representation and segment grid representation are matched using DP, and relation between columns at a grid point and a score of matching at that time are acquired. In this processing, if the similarity of matching is equal to or below a preset criterion, matching fails. The details of the matching process using DP will be described later, referring to FIGS. 13 and 14.

In the step 1140, a row where a score of matching is maximum of segment grid representation is selected. In the examples shown in FIGS. 9 and 12, as a result of matching a zeroth row to a sixth row in segment grid representation with a zeroth row in format grid representation, a second row where the similarity of matching is maximum is selected. A first row and the succeeding rows in format grid representation are also similar.

In a step 1150, the validity of matching is verified every row based upon the result of matching of the optimum row acquired in the step 1140 in segment grid representation. The details of the processing will be described later.

In case there is no row where the similarity of matching exceeds the criterion in the step 1140 and in case validity in a column cannot be verified in the step 1150, matching in units of field fails.

Referring to FIGS. 13 and 14, matching using DP in the step 1130 will be described below. FIG. 13 shows a matching matrix for matching a crossing point code of a first row in format grid representation shown in FIG. 9B and a crossing point code of a third row in segment grid representation shown in FIG. 12B using DP. A DP network which is the result of DP matching can be configured on the matching matrix. At each node of the DP network, only three types of rightward and diagonally downward transition, rightward transition, and downward transition are allowed. In this network, rightward and diagonally downward transition means that a grid point in an input image and a grid point in format information are matched. Rightward transition means that there is no grid point to be matched in the input image. Conversely, downward transition means that a grid point not included in format information exists in the input image.

Next, a method of acquiring an optimum matching path in the DP network based upon a method of calculating a score of matching will be described. A score of a node in the matching matrix is calculated in order from a left column to a right column. First, the most left column of the matching matrix is initialized. For a score of the other nodes, transition in which the sum of a score of a node before transition and a score of a node after transition is maximum out of three types of transition from the left, transition from the top, and transition from the upper left is selected and the score becomes a score of the node.

Referring to FIG. 14, the calculation of a score of a node will be concretely described below. To acquire a score of a node 1430, scores of the three types of transition from a node 1400, from a node 1410, and from a node 1420 are compared. When a value in a node is a score of the node and a value on a line of transition is a score of the transition, a score of transition from 1400 is 8 and maximum. As a result, transition from 1400 to 1430 is selected and a score of 1430 becomes 8. The details of the calculation of a score of transition will be described later.

Scores of all nodes are calculated as described above. A node having the highest score in the most right column is selected and a path having the node at a terminal is selected as a path showing the optimum matching result. In FIG. 13, a path shown by a thick line is an optimum path. A score of a terminal node of the optimum path shows the similarity of matching using DP.

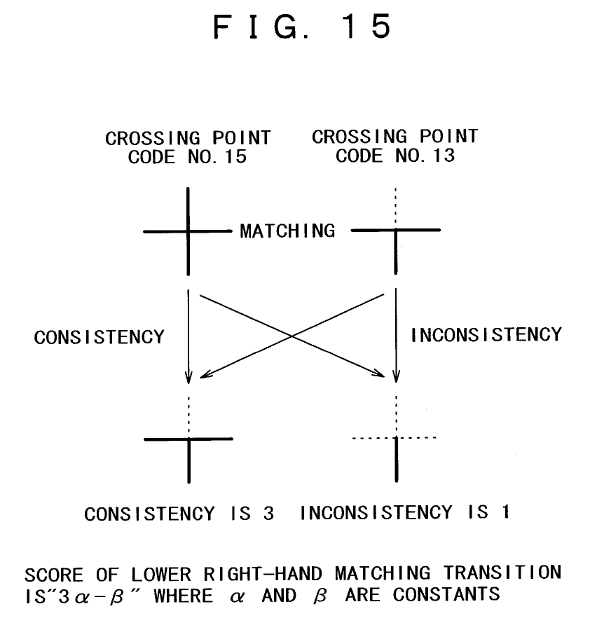

An example of the calculation of a score of transition at each node will be described below. First, rightward and downward transition meaning correspondence will be described. FIG. 15 shows an example of the calculation of a score in case grid points of a crossing point code 15 and a crossing point code 13 are matched. This transition is defined so that the higher the consistency of crossing point codes of grid points to be matched is, the higher a score is. The transition is defined as a value acquired by subtracting inconsistency from the consistency of whether a rule exists in four directions with a grid point in the center or not. In an example shown in FIG. 15, the existence of rules in three directions of four directions is consistent and only in a downward direction, the existence of a rule is inconsistent. Therefore, a score of matching transition is (3α−β). “α” and “β” are constants.

Next, downward transition meaning insertion will be described below. For insertion, a score is separately calculated in a case of insertion into a location for a rule to exist and in a case of insertion into a location having no rule. In case a grid point is inserted between a zeroth column and a first column in format grid representation shown in FIG. 13, a horizontal rule should exist. Therefore, in such a situation, the calculation of a score similar to the correspondence described above is made between a crossing point code 5 (a part of a horizontal rule) and a crossing point code of an input image. In the meantime, in case a grid point is inserted between the first column and a second column, a rule should not exist. Therefore, in such a situation, the calculation of a score similar to the correspondence is made between a crossing point code 0 (no rule) and a crossing point code of the input image.

Finally, rightward transition meaning deficiency will be described. As this transition means that no grid point to be matched exists, a score of matching is defined as (−γ) as a penalty. “γ” is a constant.

The calculation of scores describe above are an example. Each coefficient may be also variable and another criterion of evaluation such as an interval between grid points may be also adopted. In case an interval between grid points is adopted as the criterion of evaluation, the precision of matching can be enhanced because the consistency of an interval between rules and an interval between crossing points can be evaluated. In the case of a form hardly having variation in the size of a cell and often having variation in the same position, greater effect is acquired.

A thick arrow shown in FIG. 13 shows the optimum result of matching acquired in such calculation of a score. In this example, result that grid points in zeroth, first, and second columns in format grid representation correspond to grid points in 42nd, 44th and 54th columns in segment grid representation is acquired. In the 42nd column in segment grid representation, a leftward unnecessary rule exists. However, as this grid point is related to the left end of format grid representation, the existence of a leftward rule is ignored as a boundary condition. This processing is executed at the upper end, the lower end, the left end, and the right end.

Matching using grid representation and DP is described above. However, a matching method is not limited to this example. Though the precision of matching is inferior, matching by simply comparing rules and the coordinate values of cells may be also made.

Next, referring to an example shown in FIG. 16, verification in a direction of a column will be described. FIG. 16 shows the result of matching acquired in the step 1140 of each row in format grid representation. A zeroth row in format grid representation corresponds to a second row in segment grid representation. The zeroth, first, and second columns in format grid representation correspond to the 42nd, 44th, and 54th columns in segment grid representation. It is determined that the 42nd and 54th columns correspond to the zeroth and second columns in format grid representation because the same result is acquired on all rows. However, while the result of matching on zeroth, first, and third rows in the first column is 44, the result of matching on the second-row is 49 and inconsistency occurs. For an example corresponding to such inconsistency, majority decision can be given. In this case, as the three results of 44 are acquired and one result of 49 is acquired, 44 is selected. For another measure, the sum of scores of matching on the row on which the result of 44 is acquired and the sum of scores of matching on the row on which the result of 49 is acquired are compared.

As described above, a row and a column in format grid representation in a segment can be determined.

When a row and a column in format grid representation are determined, the coordinates of a cell in an input image can be acquired utilizing the positions of corners of the cell and the attribute of the cell shown in FIG. 10. To explain using the “kana” field as an example, grid points corresponding to the four corners of a cell registered in segmented format information in the grid representation of an input image are (44, 3), (44, 4), (54, 4), and (54, 3) counterclockwise from the upper left. The coordinates of the four corners of the “kana” field can be acquired by detecting coordinates at these grid points in the input image.

The similarity of matching every segmented format can be defined by the sum of scores of matching calculated on each row. In case plural segmented formats exist in the same segment, a segmented format the similarity of matching of which is maximum is selected.

The similarity of matching every form type can be defined by the sum of the similarity of matching calculated every segment in a segmented format. In case there are plural types of forms to be processed, a form the similarity of the matching of a format type of which is maximum is selected.

Next, a character reader utilizing the form processing system according to the invention will be described. An image of a character or a character string is extracted from an input image utilizing the coordinates of a read field acquired by form processing shown in FIG. 2. The character on the form can be identified by detecting and identifying the character from the extracted image. This processing may be also executed by CPU (30) utilized in the form processing shown in FIG. 2. Therefore, the form processing system shown in FIG. 2 and the character reader utilizing the form processing system can be realized by the same configuration.

Next, a method of generating segmented format information used in the invention will be described.

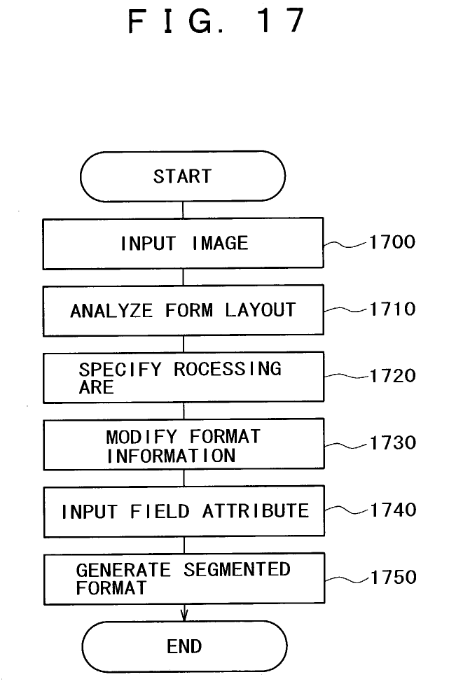

FIG. 17 is a flowchart for generating segmented format information. In a step 1700, an image on a form is input from the image input device 20 or the image database 60. In a step 1710, the analysis of the layout of the image such as the extraction of a rule is executed and grid representation is generated. In a step 1720, grid representation in a specified field is extracted from the grid representation generated in 1710 based upon the specification of a field from a segmented format to be generated input from the input device 10. The result of extracting the grid representation is displayed on the display device 50. The grid representation at this stage may include an error caused by a faint line in the image and noise. Therefore, in a step 1730, the grid representation acquired in 1720 is corrected based upon the corrected contents of the error specified via the input device 10. The result of the correction of a grid point is displayed on the display device 50. Work for correction is repeated until a user judges that no error is included. The extracted grid representation is recorded in recording means. In a step 1740, the identification information of a segment in the grid representation corrected in 1730 and attribute information such as the position and the item name of a read item are input via the input device 10. In a step 1750, the information till 1740 is converted to a predetermined data format using a conversion rule held in a suitable device and segmented format information is generated. To acquire the segmented format information of the whole form in the flow shown in FIG. 17, the step 1720 may be also omitted. If the grid representation acquired 1710 includes no error, the step 1730 may be also omitted. In case the grid representation acquired in 1710 includes many errors because the quality of an image on the form is low, the processing of another image on the form can be also executed from 1700. Further, all information can be also input from the input device 10 without analyzing a format in 1710.

Next, a method of additionally generating the segmented format information of a form which cannot be processed by the existing segmented format information will be described.

First, an image on the form to be additionally generated is input and is recognized using the existing segmented format information. A segment which can be processed by the existing segmented format information and can be specified by matching is displayed. For an example of the display method, a segment which can be matched is displayed on the image in color-coding. As a result of the display, a field unclassified in color can be judged as a field which cannot be processed by the existing segmented format information. A field of added segmented format information can be specified by automatically detecting the field or specifying the area from the input device 10. Segmented format information can be added by executing processing following the step 1730 shown in FIG. 17.

As described above, according to the invention, the semi-fixed form in which the position and the size of a cell are different every form and the arrangement of a cell is different though the form has the same form type can be precisely recognized by utilizing segmented format information. Further, effect that a man-hour for generating format information can be reduced, compared with that in the conventional type is produced. Further, effect that the capacity of format information can be reduced is produced.

System and Method Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, storing formation information of a plurality of fields of a form, acquiring an image of a plurality of, segments of the form, reading the format information of the plurality of fields of the form from the storage device, matching the format information of the plurality of segments with corresponding format information of the plurality of fields to obtain matching results, and combining the format information of the plurality of segments with corresponding format information of the plurality of fields based upon the matching results in order to, and obtaining a determined format of the image, according to processes of the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A form processing system comprising:
a storage device configured to store format information of a plurality of fields of a form;
an image input device configured to acquire an image of a plurality of segments of the form;
a reading device configured to read the format information of the plurality of fields of the form from the storage device;
a matching device configured to match format information of the plurality of segments with corresponding format information of the plurality of fields to obtain matching results; and
a combining device configure to combine the format information of the plurality of segments with corresponding format information of the plurality of fields based upon the matching results, wherein the combining device is further configured to obtain a determined format of the image.

2. The form processing device of claim 1, wherein the matching device is further configured to:
extract a feature associated with the format information of the plurality of segments;
matching the feature to format information of the plurality of fields; and
use format information of the plurality of fields which is the most similar to the feature as the matching results.

3. The form processing system of claim 1, further comprising a character recognition device configured to recognize a character in the image using the determined format of the image and attribute information related to the determined format of the image, wherein the attribute information is stored in the storage device.

4. The form processing system of claim 2, further comprising a character recognition device configured to recognize a character in the image using the determined format of the image and attribute information related to the determined format of the image, wherein the attribute information is stored in the storage device.

5. A method for form processing, the method comprising:
acquiring an image of a form;
displaying the image;
analyzing the layout of the image;
extracting a grid representation of the layout of the image;
storing the grid representation into a storage device;
specifying a segment of the image;
reading the grid representation as applied to the segment from the storage device; and
relating attribute information of the segment to the grid representation to obtain relation results; and
storing the relation results in the storage device, wherein the step of reading and the step of relating are applied to a segment newly specified in a field other than the segment.

6. The method of claim 5, wherein the steps of the method are stored as one or more instructions on a computer-readable medium, wherein the instructions, when executed by one or more processors of a computer, cause the computer to perform the steps of the method.

7. A method for form processing on a system having a storage device, the method comprising:
storing format information of a plurality of fields of a form;
acquiring an image of a plurality of segments of the form;
reading the format information of the plurality of fields of the form from the storage device;
matching the format information of the plurality of segments with corresponding format information of the plurality of fields to obtain matching results; and
combining the format information of the plurality of segments with corresponding format information of the plurality of fields based upon the matching results; and
obtaining a determined format of the image.

8. The method of claim 7, wherein the format of the plurality of fields includes a format grid representation, wherein the method further comprises extracting a segments grid representation from the image of the plurality of segments of the form, wherein the step of matching includes using the format grid representation and the segments grid representation.

9. The method of claim 7, wherein the step of matching is executed using dynamic programming.

10. The method of claim 7, wherein the steps of the method are stored as one or more instructions on a computer-readable medium, wherein the instructions, when executed by one or more processors of a computer, cause the computer to perform the steps of the method.

11. The method of claim 7, further comprising:
judging whether no matching results are to be obtain in the step of matching, wherein a case of no matching results occurs the matching step acquires a value of less than a predetermined value;
displaying a segment associated with the case of no matching results;
analyzing a layout of the segment associated with the case of no matching results;
extracting a layout grid representation from the layout;
relating attribute information of the segment associated to the case of no matching results and to the layout grid representation in order to obtain a relation result; and
storing the relation result in the storage device, wherein the step of combining includes using the relation result.

12. The method of claim 8, further comprising:
judging whether no matching results are to be obtain in the step of matching, wherein a case of no matching results occurs the matching step acquires a value of less than a predetermined value;
displaying a segment associated with the case of no matching results;
analyzing a layout of the segment associated with the case of no matching results;
extracting a layout grid representation from the layout;
relating attribute information of the segment associated to the case of no matching results and to the layout grid representation in order to obtain a relation result; and
storing the relation result in the storage device, wherein the step of combining includes using the relation result.

13. The method of claim 9, further comprising:
judging whether no matching results are to be obtain in the step of matching, wherein a case of no matching results occurs the matching step acquires a value of less than a predetermined value;
displaying a segment associated with the case of no matching results;
analyzing a layout of the segment associated with the case of no matching results;
extracting a layout grid representation from the layout;
relating attribute information of the segment associated to the case of no matching results and to the layout grid representation in order to obtain a relation result; and
storing the relation result in the storage device, wherein the step of combining includes using the relation result.
